(19) United States
(12) Patent Application Publication
(10) Pub. No.: US 2025/0215588 A1
(43) Pub. Date: Jul. 3, 2025

(54) GAS-PERMEABLE ELECTRONICALLY CONDUCTIVE PLATE FOR USE AS POROUS TRANSPORT LAYER FOR AN ELECTROLYZER

(71) Applicant: BASF SE, Ludwigshafen am Rhein (DE)

(72) Inventors: Benjamin SCHMIDT-HANSBERG, Ludwigshafen am Rhein (DE); Daniel MALKO, Ludwigshafen am Rhein (DE); Sherif Aly Hassan Aly MADKOUR, Ludwigshafen am Rhein (DE)

(21) Appl. No.: 18/867,547

(22) PCT Filed: May 25, 2023
(86) PCT No.: PCT/EP2023/064056

§ 371 Date: Nov. 20, 2024

(30) Foreign Application Priority Data
May 27, 2022 (EP) 22175781.8

(51) Int. Cl. C25B 9/75; C25B 9/23; C25B 9/65; C25B 9/77

(52) U.S. Cl. CPC C25B 9/75; C25B 9/23; C25B 9/65; C25B 9/77

(57) ABSTRACT

Described are a gas-permeable electronically conductive plate for use as porous transport layer for an electrolyzer and a process for preparing said gas-permeable electronically conductive plate. a building unit for an electrolyzer, and an electrolyzer.

Described are a gas-permeable electronically conductive plate for use as porous transport layer for an electrolyzer and a process for preparing said gas-permeable electronically conductive plate. Also described are a building unit for an electrolyzer, and an electrolyzer.

In an electrolyzer producing gaseous products like hydrogen and oxygen, porous transport layers provide transport passages for liquid educts like water and gaseous products like oxygen and hydrogen. At the same time, said porous transport layers have to provide electronic contact to the bipolar plate adjacent a first surface of the porous transport layer and to the catalyst layer adjacent the second surface of the porous transport layer. Thus, such porous transport layer is required to have a low pressure drop to facilitate the fluid transport, and a large contact area with the catalyst layer to ensure maximum utilization of the catalyst. Both requirements are contradictory, since maximized catalyst interface requires small pores resulting in poor mass transfer, while maximized mass transfer requires large pores resulting in minimized interface with the catalyst interface.

### RELATED PRIOR ART IS

CN 111 621 806 A
EP 3 686 318 A1
JP 2009 181918 A
EP 3 939 722 A1
US 2015/376800 A1

US 2005/181264 A1. The not prepublished PCT-application WO 2023/061869 of the same applicant discloses a porous transport layer for an electrolyzer of the proton exchange membrane (“PEM”) construction type. Said porous transport layer has a bilayer structure or a multilayer structure. The layers of the bilayer structure or multilayer structure, resp., have different average pore diameter and/or different porosity, and are arranged in such manner that the layer with the highest porosity and/or with the highest average pore diameter is in contact with the bipolar plate, and the layer with the lowest porosity and/or the lowest average pore diameter is in contact with the catalyst layer. Said multilayer structure is obtainable by coextruding different mixtures each comprising metallic particles and a polymer binder. The porosity and/or pore diameter of the coextruded layers are controlled by suitably adjusting one or both of the average particle size of the metallic particles and the content of the metal particles of the coextruded mixtures. The higher the average particle size of the metallic particles in the mixture is the higher are the pore diameter and the porosity of the obtained layer. The higher the content of the metallic particles in the mixture is the lower are the pore diameter and the porosity of the obtained layer. This adjustment of average pore diameter and porosity is advantageous. Nevertheless, in such porous transport layer fluid transport is possible only via pores; and increasing the average pore diameter and porosity has certain limitations due to stability reasons. Moreover, pores inevitably have a tortuosity which imposes further limitations to the fluid transport.

Thus, there is a need for a porous transport layer allowing for increased fluid transport without compromising electronic contact with the catalyst layer and mechanical stability. The present invention is directed to resolving the contradictory relation between the requirements of maximizing the catalyst interface of the porous transport layer and maximizing the fluid transport through the porous transport layer.

In order to solve this problem, according to a first aspect there is provided a gas-permeable electronically conductive plate for use as porous transport layer for an electrolyzer. Said gas-permeable plate
comprises metallic particles of one or more selected from the group consisting of titanium, titanium alloys and stainless steel,
has a plurality of pores having an average pore diameter,
has a first surface and a second surface opposite to each other, and a thickness dimension extending perpendicular to said first surface and said second surface,
wherein the first surface of said gas-permeable electronically conductive plate has one or more recesses extending from said first surface into the thickness of the gas-permeable electronically conductive plate,
said recesses having a lateral dimension at said first surface of the gas-permeable electronically conductive plate which is larger than the average pore diameter of the pores.

The gas-permeable electronically conductive plate according to the first aspect comprises or consists of metallic particles of one or more selected from titanium, titanium alloys and stainless steel. Mixtures of metallic particles selected from titanium, titanium alloys and stainless steel are also possible. The metallic particles essentially consist of one or more selected from the group consisting of titanium, titanium alloys and stainless steel. Presence of minor amounts of other components, in particular, unavoidable impurities which do not detrimentally influence the chemical and mechanical properties of the metallic particles is not excluded.

Preferably, the metallic particles forming the gas-permeable electronically conductive plate are sintered together. The composition of the metallic particles may vary along the thickness dimension of the gas-permeable electronically conductive plate.

The gas-permeable electronically conductive plate has a first surface which is configured to be in contact with a bipolar plate of an electrolyzer, and a second surface which is configured to be in contact with a catalyst layer of an electrolyzer. Said first surface and said second surface of said gas-permeable electronically conductive plate are opposite to each other. Said first surface and said second surface are the largest surfaces of the gas-permeable electronically conductive plate. The dimension of the gas-permeable electronically conductive plate, which extends perpendicular to said first surface and said second surface, is referred to as the thickness dimension of the gas-permeable electronically conductive plate.

The gas-permeable electronically conductive plate is porous. The pores extend between the metallic particles. Preferably, a gas-permeable electronically conductive plate according to the invention has a porosity in the range of from 10 vol % to 80 vol %, preferably 30 vol % to 60 vol %, as measured by volume intrusion mercury porosimetry in accordance with DIN 66133. The pores have a dimension referred to as the average pore diameter. Preferably, the average pore diameter is in the range of from 5 μm to 40 μm as measured by volume intrusion mercury porosimetry in accordance with DIN 66133. More preferably, the porosity is in the range of from 10 vol % to 80 vol %, preferably 30 vol % to 60 vol %, as measured by volume intrusion mercury porosimetry in accordance with DIN 66133, and the average pore diameter is in the range of from 5 μm to 40 μm as measured by volume intrusion mercury porosimetry in accordance with DIN 66133.

Both, the porosity and the pore diameter may vary along the thickness dimension of the gas-permeable electronically conductive plate. Preferably the porosity and/or the average pore diameter decrease in the direction from the first surface towards the second surface of the gas permeable electronically conductive plate, so that the porosity and/or the average pore diameter reach a maximum at the first surface of the gas-permeable electronically conductive plate which is configured to be in contact with the bipolar plate, and the porosity and/or the average pore diameter reach a minimum at the second surface of the gas-permeable electronically conductive plate which is configured to be in contact with the catalyst layer.

The variation of the porosity and/or of the average pore diameter along the thickness dimension may be stepwise (resulting in a bilayer or multilayer structure of the gas-permeable electronically conductive plate) or substantially continuously. A process for preparing a gas-permeable electronically conductive plate having a multilayer structure is described in the not prepublished PCT-application WO 2023/061869 of the same applicant.

The first surface of said gas-permeable electronically conductive plate has one or more recesses extending from said first surface into the thickness of the gas-permeable electronically conductive plate. Each of the recesses has a lateral dimension at the first surface of the gas-permeable electronically conductive plate, i.e. a lateral dimension measured at the level of the first surface of the gas-permeable electronically conductive plate. Each of the recesses has a dimension extending into the thickness of the gas-permeable electronically conductive plate. Said dimension extending into the thickness of the gas-permeable electronically conductive plate is referred to as the depth of the recess.

Said one or more recesses serve as passages for fluid flow.

For instance, such recess extends from the first surface through the whole thickness of the gas-permeable electronically conductive plate, thus reaching the second surface of the gas-permeable electronically conductive plate. A recess of this type has a depth equal to the thickness of the gas-permeable electronically conductive plate and is referred to as a through-hole. A recess of this type facilitates fluid transport across the gas-permeable electronically conductive plate towards the catalyst layer resp. away from the catalyst layer.

Alternatively, such recess extends from the first surface of the gas-permeable electronically conductive plate into a depth less than the whole thickness of the gas-permeable electronically conductive plate, thus not reaching the second surface of the gas-permeable electronically conductive plate. Such recess having a depth lower than the thickness of the gas-permeable electronically conductive plate may be in the form of a groove or a dimple, or in the form of a recessed area extending around one or more island-like (i.e. insular) non-recessed sections. Combinations of different types of recesses are possible. A recess of this type facilitates fluid transport in the lateral direction of the gas-permeable electronically conductive plate and reduces the distance the reactants must migrate via pores to reach the catalyst layer resp. to be removed from the catalyst layer.

Details of different types of recesses will be described below.

Each of the recesses has a lateral dimension at the first surface of the gas-permeable electronically conductive plate, i.e. a lateral dimension measured at the level of the first surface of the gas-permeable electronically conductive plate. In the case of a recess in the form of a through-hole, said lateral dimension corresponds to the width of said through-hole as measured on the level of said first surface of the gas-permeable electronically conductive plate. In the case of a recess in the form a dimple or a groove, said lateral dimension corresponds to the width of the dimple or the groove as measured on the level of said first surface of the gas-permeable electronically conductive plate. In the case of a recessed area extending around one or more island-like (insular) non-recessed sections, said dimension is the distance between the margins of neighboring non-recessed sections as measured on the level of said first surface of the gas-permeable electronically conductive plate.

Said lateral dimension of the recess at the first surface of the gas-permeable electronically conductive plate is larger than the average pore diameter. Thus, the recesses may significantly reduce the pressure drop in the porous transport layer, compared to a porous transport layer having the same design except for the absence of the recesses, so that mass transfer is achieved only via the pores. In addition, the contact area between the porous transport layer and the catalyst is retained or is not substantially reduced, compared to a porous transport layer having the same design except for the absence of the recesses.

It is understood that the thickness of the gas-permeable electronically conductive plate refers to and is determined at a position where no recess is situated. Preferably, a gas-permeable electronically conductive plate according to the invention has a thickness in the range of from 20 μm to 2000 μm as measured at a position where is no recess.

In a first preferred embodiment, the gas-permeable electronically conductive plate has one or more recesses in the form of a through-hole extending from said first surface to said second surface of said gas-permeable electronically conductive plate, said through-hole having
a central axis extending perpendicular from said first surface to said second surface of the gas-permeable electronically conductive plate
and a width at the level of first surface of the gas-permeable electronically conductive plate.

Such through-hole may have a circular, oval, square, polygonal or any other suitable contour. The width of the trough-hole at the level of the first surface of the gas-permeable electronically conductive plate is larger than the average pore diameter of the pores of said gas-permeable electronically conductive plate. Preferably, the width of the trough-hole at the level of the first surface of the gas-permeable electronically conductive plate is in the range of from 20 μm to 1000 μm, preferably 40 μm to 800 μm, more preferably 50 μm to 600 μm. In the case of a through-hole having a circular contour, the width corresponds to the diameter of the through-hole. Preferred are through-holes having a diameter or width which is tapered in the direction from the first surface to the second surface of the gas-permeable electronically conductive plate, so that the loss of contact interface with the catalyst layer at the second surface of the of the gas permeable electronically conductive plate is reduced. Compared to pores, such through-holes substantially do not exhibit tortuosity, so that mass transfer is facilitated and pressure drop is reduced.

In addition to through-holes, a gas-permeable electronically conductive plate according to the first embodiment may have one or more recesses at the first surface, wherein said recesses have a depth which is lower than the thickness of the gas-permeable electronically conductive plate at a non-recessed position. Such recesses may be in the form of a dimple or a groove or in the form of a recessed area extending around one or more island-like (insular) non-recessed sections (for details see below). Combinations of different types of such recesses are possible.

In a second preferred embodiment, the gas-permeable electronically conductive plate has one or more recesses at the first surface which have a depth which is lower than the thickness of the gas-permeable electronically conductive plate at a non-recessed position, and no recesses having a depth equal to the thickness of the gas-permeable electronically conductive plate are present. Thus, in the second embodiment, the gas-permeable electronically conductive plate has no such through-holes as defined above in the context of the first embodiment.

In a gas-permeable electronically conductive plate according to the first embodiment or to the second embodiment, one or more of said recesses at the first surface having a depth which is lower than the thickness of the gas-permeable electronically conductive plate may be in a form of a dimple. The width of the dimple at the level of the first surface of the gas-permeable electronically conductive plate is larger than the average pore diameter of the pores of said gas-permeable electronically conductive plate. Preferably, said dimple has a width of from 10 μm to 5000 μm at the level of the first surface of the gas permeable electronically conductive plate. Such dimple may have a circular, oval, square, polygonal or any other suitable contour. In the case of a circular dimple, the width corresponds to the diameter of the dimple. Such dimple may have a U-shaped, V-shaped (triangular), square, semi-circle or any other suitable cross section.

Recesses in the form of a dimple are advantageous over recesses in the form of a through-hole because at the second surface of the gas-permeable electronically conductive plate loss of contact with the catalyst layer is avoided, and within the gas-permeable electronically conductive plate loss of electronically conductive material is reduced.

Recesses in the form of a dimple are advantageous over recesses in the form of a groove (channel), because dimples allow for a one-dimensional mass transport of oxygen along the thickness direction of the gas permeable electronically conductive plate straightforward to the flow-field of the adjacent bipolar plate. In contrast, with grooves the mass transport of oxygen will be two-dimensional first through the thickness of the gas permeable electronically conductive plate into the groove, and then in the lateral direction along the groove. Thus, for optimizing the mass transport of oxygen via recesses in the form of grooves, the pattern of the grooves on the gas permeable electronically conductive plate has to be designed to cooperate with the structure of the flow-field at the adjacent surface of the bipolar plate (see below). In contrast, dimples may readily cooperate with a wide variety of flow field structures.

In a gas permeable electronically conductive plate having recesses in the form of dimples, said dimples provide mass flow pathways having reduced flow resistance for the transport of oxygen generated at the catalyst layer towards the bipolar plate, while the adjacent non-recessed porous sections of the gas permeable electronically conductive plate provide mass flow pathways for the transport of water by capillary forces towards the catalyst layer. Thus, a plurality of separate transport pathways for oxygen and a plurality of separate transport pathways for water is created in close proximity to each other.

Moreover, recesses in the form of a dimple are favorable with regard to the mechanical stability of the gas permeable electronically conductive plate. In contrast, recesses in the form of a groove might be seeding points for fracture if the gas permeable electronically conductive plate is subject to bending stress.

In a preferred gas permeable electronically conductive plate according to the invention, all recesses are in the form of dimples, wherein the dimples are evenly distributed over the first the surface of the gas permeable electronically conductive plate.

The gas permeable electronically conductive plate may have a bilayer structure (as described above) consisting of a first layer and a second layer, wherein said first layer which is configured to be in contact with a bipolar plate has a higher porosity and/or a higher average pore diameter than said second layer which is configured to be in contact with a catalyst layer. In case the gas-permeable electronically conductive plate has such bilayer structure, it may be preferable that the depth of the dimples extends over 80 to 100%, preferably 90 to 100% of the thickness of the first layer having the higher porosity and/or the higher average pore diameter. In case the depth of said dimples extends over 100% of the thickness of the first layer having the higher porosity and/or the higher average pore diameter, the depth of said dimples may further extend over at most 50%, preferably at most 10% of the thickness of the second layer having the lower porosity and/or the lower average pore diameter. Thus, in case the depth of said dimples extends over 100% of the thickness of the first layer, the depth of said dimples may further extend from 0 to 50%, preferably from 0 to 10% of the thickness of said second layer.

Limiting the depth of the dimples in such manner has the advantage of avoiding excessive densification of the porous structure near the second surface of the gas-permeable electronically conductive plate which is configured to be in contact with the catalyst layer, or even in a deformation of said second surface of the gas-permeable electronically conductive plate.

In a gas-permeable electronically conductive plate according to the first embodiment or to the second embodiment, one or more of said recesses at the first surface having a depth which is lower than the thickness of the gas-permeable electronically conductive plate may be in a form of a groove. The width of the groove at the level of the first surface of the gas-permeable electronically conductive plate is larger than the average pore diameter of the pores of said gas-permeable electronically conductive plate. Preferably, said groove has a width of 10 μm to 5000 μm as measured at the level of the first surface of the gas permeable electronically conductive plate. Said grove may have a straight, meander-like, zig-zag, serpentine, honeycomb or any other suitable course. Such groove may have a U-shaped, V-shaped (triangular), angular, square, semi-circle or any other suitable cross section. The groove may form a continuous channel extending from a fluid inlet to a fluid outlet.

In a gas-permeable electronically conductive plate according to the first embodiment or to the second embodiment, a recess at the first surface having a depth which is lower than the thickness of the gas-permeable electronically conductive plate extends around one or more island-like (insular) non-recessed sections. Each non-recessed section has a top surface at the level of the first surface of the gas-permeable electronically conductive plate. The recessed area surrounding the non-recessed sections provides a passage for fluid flow around the non-recessed sections which provide for electronic contact with the bipolar plate. The lateral distance between the margins of neighboring non-recessed sections at the level of the first surface of the gas-permeable electronically conductive plate is larger than the average pore diameter of the pores of said gas-permeable electronically conductive plate. Preferably, the lateral distance between the margins of neighboring non-recessed sections at said first surface is in the range of from 20 μm to 5000 μm as measured at the level of the first surface. The island-like (insular) non-recessed sections may have a form of a ridge, a dam, a column, a pillar, a honeycomb, a truncated pyramid, a truncated conus, a step-like or staircase-like structure (i.e. a structure tapering towards the first surface of the gas-permeable electronically conductive plate), or any other suitable structure. Combinations of non-recessed sections having different structures are possible.

Most preferably, a gas-permeable electronically conductive plate according to the above-defined first aspect is applied as porous transport layer at the anode side of the electrolysis cells of an electrolyzer for electrolysis of water, where oxygen is formed. Here, due to the favorably low pressure drop, the gas-permeable electronically conductive plate according to the above-defined first aspect facilitates the transport of water into the porous transport layer, and the escape of generated oxygen away from the porous transport layer.

According to a second aspect, a building unit for an electrolyzer is provided. Said building unit comprises or consists of
a gas-permeable electronically conductive plate according to the above-defined first aspect
and at least one of
   a gas-impermeable electronically conductive bipolar plate in contact with said first surface of said gas-permeable electronically conductive plate,
and
   a catalyst layer in contact with said second surface of said gas-permeable electronically conductive plate.

Electrolyzers are known in the art. Basically, an electrolyzer comprises a plurality of identical neighboring electrochemical cells which are electrically connected in series via gas-impermeable electronically conductive bipolar plates.

In the building unit according to the second aspect, said gas-permeable electronically conductive plate according to the above-defined first aspect serves as a porous transport layer. It has preferably one or more of the above-defined preferred features and/or is selected from the above-defined preferred embodiments.

In the building unit according to the second aspect, said catalyst layer preferably comprises a catalyst capable of catalyzing the electrochemical oxygen evolution reaction or hydrogen evolution reaction. Said catalyst is preferably selected from the group consisting of iridium, iridium oxide, platinum, platinum oxide, palladium, palladium oxide, ruthenium, ruthenium oxide and mixtures of the oxides listed herein. The catalyst is unsupported or is supported on a suitable catalyst carrier, for instance on a catalyst carrier selected from the group consisting of SnO₂, TiO₂, and carbon black.

In the building unit according to the second aspect, said catalyst layer is preferably an anode catalyst layer and comprises a catalyst capable of catalyzing the electrochemical oxygen evolution.

In a first preferred embodiment, a building unit according to the above-defined second aspect comprises or consists of
a gas-permeable electronically conductive plate according to the above-defined first aspect, wherein the recesses at said first surface of said gas-permeable electronically conductive plate preferably have a lateral dimension in the range of from 100 μm to 5000 μm,
and a gas-impermeable electronically conductive bipolar plate having a surface in contact with said first surface of said gas-permeable electronically conductive plate, wherein said surface of said bipolar plate which is in contact with said first surface of said gas-permeable electronically conductive plate has no recesses.

In such embodiment, the bipolar plate merely provides electronic contact between neighboring cells of the electrolyzer and does not provide any fluid flow structure. Any reactant transport occurs within the gas-permeable electronically conductive plate. In order to facilitate lateral reactant transport, it is preferred that the gas-permeable electronically conductive plate has at least one recess in the form or continuous channel or in the form of a continuous recessed area extending around a plurality of island-like (insular) non-recessed sections. Continuous means that the recess extends from a fluid inlet connected to the fluid supply manifold of the electrolyzer to a fluid outlet connected to a fluid removal manifold of the electrolyzer. The recesses at said first surface of said gas-permeable electronically conductive plate preferably have a lateral dimension (e.g. a channel width) in the range of from 100 μm to 5000 μm. This dimension is in the same range as the lateral dimension (e.g. channel width) of commonly used flow field structures for state of the art bipolar plates.

This embodiment has the advantage that the design of the building unit and of the corresponding electrolyzer is streamlined, and manufacturing of the bipolar plate is simplified, because imparting a flow field to the bipolar plate is omitted. In addition, the thickness of the bipolar plate may be reduced, thus reducing the space requirements and improving the volume-specific output of the electrolyzer.

Moreover, due to shifting the complete fluid flow into the porous transport layer, the reactants do not need to migrate through the entire thickness of the porous transport layer to reach the catalyst layer. Decreasing the distance through which the reactants must migrate to reach the catalyst layer enhances the access of the reactants to the catalyst layer, and performance and yield of an electrolyzer may be improved.

In a second preferred embodiment, a building unit according to the above-defined second aspect comprises or consists of
a gas-permeable electronically conductive plate according to the above-defined first aspect
and a gas-impermeable electronically conductive bipolar plate having a flow field surface in contact with said first surface of said gas-permeable electronically conductive plate,
wherein said flow field surface of said bipolar plate has a fluid flow structure comprising recesses extending between protruding (i.e. non-recessed) areas, wherein one or more of said protruding (non-recessed) areas extend over one or more of the recesses at the first surface of said gas-permeable electronically conductive plate,
wherein preferably the protruding areas at the flow field surface of the bipolar plate have a lateral dimension, which is larger than the lateral dimension of said recesses at said first surface of said gas-permeable electronically conductive plate.

In such embodiment, the bipolar plate and the adjacent first surface of the gas-permeable electronically conductive plate according to the above-defined first aspect cooperate in providing a fluid flow structure for the reactant transport.

The bipolar plate has a flow field surface in contact with the above-defined first surface of said gas-permeable electronically conductive plate. As explained above, said first surface of said gas-permeable electronically conductive plate has one or more recesses extending from said first surface into the thickness of the gas-permeable electronically conductive plate. The flow field surface of said bipolar plate has a fluid flow structure comprising recesses extending between protruding (i.e. non-recessed) areas. Such fluid flow structure is also referred to as a flow-field. Suitable flow-field designs are known in the art. Typically, a flow field comprises at least one recess which forms a continuous channel extending between two protruding areas which provide the walls of the channel. Continuous means that the recess extends from a fluid inlet connected to the fluid supply manifold of the electrolyzer to a fluid outlet connected to a fluid removal manifold of the electrolyzer.

In the building unit according to the above-defined second embodiment, one or more of said protruding (non-recessed) areas of the flow field surface of the bipolar plate extend in each case over one or more of the recesses at the first surface of the gas-permeable electronically conductive plate adjacent to the flow field surface of the bipolar plate.

Preferably, a protruding (non-recessed) area at the flow field surface of the bipolar plate have a lateral dimension which is larger than the lateral dimension of said recesses at said first surface of said gas-permeable electronically conductive plate adjacent to the flow-field surface of the bipolar plate. Herein, said lateral dimension of the protruding (non-recessed) area at the flow field surface of the bipolar plate is preferably in the range of from 100 μm to 5000 μm, and said lateral dimension of said recess at said first surface of said gas-permeable electronically conductive plate is preferably in the range of from 10 μm to 1000 μm.

This embodiment has the advantage that the mass transfer into and away from those areas of the gas-permeable electronically conductive plate which are covered by the protruding (non-recessed) areas of the flow field surface of the adjacent bipolar plate is improved. More specifically, escape of gaseous electrolysis products like hydrogen resp. oxygen into the flow field channels is facilitated due to the presence of lateral escape passages provided by the one or more recesses on the first surface of the gas-permeable electronically conductive plate in cooperation with the pores of the gas-permeable electronically conductive plate. Thus, the homogeneity of the mass transfer as well as of the current distribution over the area of the porous transport layer is improved, which allows for higher current densities and prevents formation of “hot-spots”. Thus, operation safety, performance and yield of an electrolyzer may be improved.

According to a third aspect, there is provided an electrolyzer comprising
a gas-permeable electronically conductive plate according to the above-defined first aspect
   or
a building unit according to the above-defined second aspect.

In the electrolyzer according to the third aspect, said gas-permeable electronically conductive plate according to the above-defined first aspect resp. said building unit according to the above-defined second aspect has preferably one or more of the above-defined preferred features and/or is selected from the above-defined preferred embodiments.

Preferably, said electrolyzer is an electrolyzer for electrolysis of water comprising an electrolyte in the form of a proton exchange membrane.

According to a fourth aspect, there is provided a process for preparing a gas-permeable electronically conductive plate according to the first aspect. Said process comprises the steps of
(i) forming a mixture comprising metallic particles of one or more selected from the group consisting of titanium, titanium alloys and stainless steel, and a polymer binder into a green body plate,
   said green body plate having a first surface and a second surface opposite to each other, and a thickness dimension extending perpendicular to said first surface and said second surface,
   wherein the first surface of said green body plate has one or more recesses extending from said first surface into the thickness of the green body plate,
   said recesses having a lateral dimension at said first surface which is in the range from 11 μm to 5500 μm,
(ii) debinding the green body plate prepared in step (i) to obtain a brown body plate
(iii) sintering the brown body plate obtained in step (ii) under a non-oxidative atmosphere or vacuum to form the gas-permeable electronically conductive plate.

The green body plate obtained in step (i) has a first surface and a second surface opposite to each other. Said first surface and said second surface are the largest surfaces of the green body plate. The dimension of the green body plate, which extends perpendicular to said first surface and said second surface, is referred to as the thickness of the green body plate.

In step (i) of the process according to the fourth aspect, a mixture comprising or consisting of
metallic particles of one or more selected from the group consisting of titanium, titanium alloys and stainless steel,
and a polymer binder
   is formed into a green body plate. In said mixture, preferably the volume fraction of said metallic particles is in the range of from 40 vol % to 70 vol %, further preferably of from 45 vol % to 65 vol %, and the volume fraction of said polymeric binder is in the range of from 30 vol % to 60 vol %, preferably 35 vol % to 55 vol %, all values based on the total volume of the mixture. Techniques for preparing such mixtures are known in the art.

The mixture may be in the form of a powder mixture or of a slurry containing metallic particles and the binder. Alternatively, the mixture may be in the form of a granulate obtained by compounding the metallic particles with a liquid binder, a liquefied binder, or a solid binder. Compounding techniques are known in the art. Typically, compounding is carried out by means of a compounder (e.g. twin-screw extruder, kneader, planetary extruder) or an extruder.

The metallic particles are selected from one or more of titanium, titanium alloys and stainless steel. Mixtures of metallic particles selected from titanium, titanium alloys and stainless steel are also possible. The metallic particles essentially consist of one or more selected from the group consisting of titanium, titanium alloys and stainless steel. Presence of minor amounts of other components, in particular, unavoidable impurities which do not detrimentally influence the chemical and mechanical properties of the metallic particles is not excluded.

Preferably, said metallic particles have an average particle size of from 15 μm to 106 μm as measured by laser diffraction. The average particle size of the metallic particles may vary along the thickness direction of the green body plate. The variation of the average particle size of the metallic particles along the thickness dimension may be stepwise (resulting in a bilayer or multilayer structure of the gas-permeable electronically conductive plate) or substantially continuously. By adjusting the particle size of the metallic particles in the mixture, the average pore diameter of the resulting gas permeable electronically conductive plate may be controlled. The average pore diameter increases with the average particle size of the metallic particles. Preferably, the average particle size of the metallic particles decreases along the thickness in the direction from the first surface towards the second surface of the green body plate formed in step (i), so that in the resulting gas permeable electron conductive plate the average pore diameter reaches its maximum at the first surface of the gas-permeable electronically conductive plate which is configured to be in contact with the bipolar plate, and the average pore diameter reaches its minimum at the second surface of the gas-permeable electronically conductive plate which is configured to be in contact with the catalyst layer.

A process for obtaining such a multilayer structure is described in the not prepublished PCT-application WO 2023/061869 of the same applicant.

The desired particle size distribution of the metallic particles is obtained by means of sieving or classifying.

Techniques for obtaining metallic particles as used in the above-defined process are known in the art. For example, a metallic material selected from titanium, titanium alloys and stainless steel may be ground into particles. The grinding may take place in a classifier mill, in a hammer mill or in a ball mill. Alternatively, metallic particles as used in the above-defined process may be obtained by atomization. Any suitable technique may be used for atomization of a material selected from titanium, titanium alloys and stainless steel. Such techniques are known in the art. Suitable atomization techniques for titanium are e.g. plasma atomization (PA), Electrode Inert Gas Atomization (EIGA) and Hydrogenation dehydrogenation (HDH).

Plasma-treatment of the metallic particles may be performed to improve the sphericity of the metallic particles and to remove contaminants.

Suitable binders are known in the art. Typically, the binder is an organic polymer.

A preferred binder comprises or essentially consists of
(b1) from 40 to 97.5% by weight of one or more polyoxymethylenes (POM),
(b2) from 1 to 35% by weight of one or more polyolefins (PO),
(b3) either no further polymer (FP) or from 0.5 to 20% by weight of one or more further polymers (FP), and
(b4) either no dispersant or from 0 to 5% by weight of at least one dispersant,
each based on the total weight of the binder, where the % by weight of (b1), (b2), (b3) and (b4) add up to 100%. In said binder, the POM differs from the PO, the PO differs from the FP, the FP differs from the dispersant and the dispersant differs from the POM.

The term “polyoxymethylene” or “POM” encompasses POM itself, i.e. polyoxymethylene homopolymers, and polyoxymethylene copolymers and polyoxymethylene terpolymers. The one or more polyolefins are preferably selected from the group consisting of polymethylpentene, poly-1-butene, polyisobutylene, polyethylene and polypropylene. The one or more further polymers are preferably selected from the group consisting of a polyether, a polyurethane, a polyepoxide, a polyamide, a vinyl aromatic polymer, a poly(vinyl ester), a poly(vinyl ether), a poly(alkyl(meth)acrylate) and copolymers thereof. The one or more dispersants are preferably selected from the group consisting of oligomeric polyethylene oxide having a low molecular weight of from 200 to 600 g/mol stearic acid, stearamides, hydroxystearic acids, fatty alcohols, fatty alcohol sulfonates and block copolymers of ethylene oxide and propylene oxide and also, particularly preferably, fatty acid esters.

Preparation of the above-defined binder and its components (b1)-(b4) is known in the art. For details, see the not prepublished PCT-application WO 2023/061869 of the same applicant.

The green body plate formed in step (i) comprises or consists of a mixture comprising or consisting of metallic particles of one or more selected from the group consisting of titanium, titanium alloys and stainless steel, and a polymer binder. In the green body plate, the metallic particles are hold together by means of the binder.

The volume ratio between the metallic particles and the binder may vary along the thickness direction of the gas-permeable electronically conductive plate. The variation of the volume ratio between the metallic particles and the binder along the thickness dimension may be stepwise (resulting in a bilayer or multilayer structure of the gas-permeable electronically conductive plate) or substantially continuously. Preferably, the volume ratio between the metallic particles and the binder increases along the thickness in the direction from the first surface towards the second surface of the green body plate formed in step (i) and/or the average particle size of the metallic particles decreases along the thickness in the direction from the first surface towards the second surface of the green body plate formed in step (i), so that in the resulting gas permeable electron conductive plate the average pore diameter reaches its maximum at the first surface of the gas-permeable electronically conductive plate which is configured to be in contact with the bipolar plate, and the average pore diameter reaches its minimum at the second surface of the gas-permeable electronically conductive plate which is configured to be in contact with the catalyst layer.

A process for obtaining such a multilayer structure is described in the not prepublished PCT-application WO 2023/061869 of the same applicant.

The first surface of said green body plate has one or more recesses extending from said first surface into the thickness of the green body plate. Each of the recesses has a lateral dimension at the first surface of the green body plate, i.e. a lateral dimension measured at the level of the first surface of the green body plate. Each of the recesses has a dimension extending into the thickness of the green body plate. Said dimension extending into the thickness of the green body plate is referred to as the depth of the recess.

For instance, such recess extends from the first surface through the whole thickness of the green body plate, thus reaching the second surface of the green body plate. A recess of this type has a depth equal to the thickness of the green plate and is referred to as a through-hole. Alternatively, such recess extends from the first surface into a depth less than the whole thickness of the green body plate, thus not reaching the second surface of the green body plate. Such recess having a depth lower than the thickness of the green body plate may be in the form of a groove or a dimple, or in the form of a recessed area extending around one or more island-like (insular) non-recessed sections. Combinations of different types of recesses are possible. Details of different types of recesses are described above in the context of the first aspect.

Each of the recesses has a lateral dimension at the first surface of the green body plate, i.e. a lateral dimension measured at the level of the first surface of the green body plate. In the case of a recess in the form of a through-hole (e.g. having a circular contour), said lateral dimension corresponds to the width of said through-hole as measured on the level of said first surface of the green body plate. In the case of a recess in the form dimple or groove, said lateral dimension corresponds to the width of the dimple or groove as measured on the level of said first surface of the green body plate. In the case of a recessed area extending around one or more island-like (insular) non-recessed sections, said lateral dimension is the distance between the margins of neighboring sections as measured on the level of said first surface of the green body plate.

The lateral dimension of said one or more recesses measured at the level of said first surface of the green body plate is preferably in the range from 11 μm to 5500 μm, preferably 50 μm to 5500 μm (especially in the case of through-holes). The lateral dimension of a recess at the first surface of the green body plate prepared in step (i) is typically larger than the lateral dimension of the corresponding recess at the first surface the resulting gas-permeable electronically conductive plate, due to the shrinkage occurring during sintering in step (iii) of the above-defined process.

It is understood that the thickness of the green body plate refers to and is determined at a position where no recess is situated. Preferably, a green body plate prepared in step (i) has a thickness in the range of from 45 μm to 3000 μm as measured at a position where is no recess. The thickness of the green body plate prepared in step (i) is typically larger than the thickness of the resulting gas-permeable electronically conductive plate, due to the shrinkage occurring during sintering in step (iii) of the above-defined process.

In a first embodiment of the process for preparing a gas-permeable electronically conductive plate, in step (i), the green body plate may be obtained in its final shape (i.e. including one or more recesses extending from said first surface into the thickness of the green body plate as defined above) by forming a mixture comprising said metallic particles and said polymer binder into said green body plate. Preferably, the mixture consists of said metallic particles and said polymer binder. Preferably said green body plate is formed by means of a technique selected from the group consisting of injection molding, mold-pressing, press-molding, or 3D-printing a mixture comprising said metallic particles and said polymer binder. Such techniques are known in the art.

In the case of 3D-printing, a granulate obtained from compounding the metallic particles with a liquid binder, a liquefied binder, or a solid binder may be transferred into a 3D printing filament by means of fused filament fabrication. Such techniques are known in the art, cf. e.g. WO 2017/009190 A1 describing a filament comprising a core material comprising an inorganic powder, the core material being coated with a layer of shell material comprising a thermoplastic polymer, and US 2016/024293 A1, disclosing the use of a mixture comprising from 40 to 70 vol % (based on the total volume of the mixture) of an inorganic powder, from 30 to 60 vol % (based on the total volume of the mixture) of a binder (B) comprising (b1) from 50 to 96 wt % of at least one polyoxymethylene (POM) based on the total weight of the binder, (b2) from 1 to 35 wt % of at least one polyolefin (PO) based on the total weight of the binder (B), (b3) from 2 to 40 wt % of at least one further polymer based on the total weight of the binder (B) in a fused filament fabrication process.

Thus, in a first embodiment of the above-defined process, step (i) comprises
(a) forming a mixture comprising said metallic particles and said polymer binder into said green body plate wherein said green body plate is preferably formed by means of a technique selected from the group consisting of injection molding, press-molding, mold-pressing, and 3D-printing a mixture comprising said metallic particles and said polymer binder.

In a second embodiment of the process for preparing a gas-permeable electronically conductive plate, in step (i) the green body plate may be obtained by forming a blank plate which has a first surface and a second surface opposite to each other, and a thickness dimension extending perpendicular to said first surface and said second surface, wherein said first surface and said second surface of said blank plate have no recesses, and subsequently transforming said blank plate into said green body plate by forming one or more recesses extending from said first surface into the thickness of the resulting green body plate.

Said blank plate has a first surface and a second surface opposite to each other, and a thickness dimension extending perpendicular to said first surface and said second surface, wherein said first surface and said second surface of said blank plate have no recesses. Said first surface and said second surface are the largest surfaces of the blank plate.

Preferably, said blank plate is formed by means of a technique selected from the group consisting plate pressing, tape casting and extrusion of a mixture comprising said metallic particles and said polymer binder. Such techniques are known in the art. For tape casting the mixture may be in the form of a slurry comprising said metallic particles and said polymer binder. For extruding, the mixture may be in the form of a granulate obtained by compounding the metallic particles with a binder. Preferably, the mixture consists of said metallic particles and said polymer binder.

For transforming said blank plate into the desired green body plate (i.e. imparting one or more recesses extending from said first surface into the thickness of the green body plate as defined above) said recesses are preferably formed by means of a technique selected from the group consisting of embossing said first surface of said blank plate and needling through the blank plate. Such techniques are known in the art. Embossing is preferred for forming recesses having a depth lower than the thickness of the green body plate. Needling is preferred for forming through-holes.

Thus, in a second embodiment step (i) comprises
(b) forming a mixture comprising said metallic particles and said polymer binder into a blank plate having a first surface and a second surface opposite to each other, and a thickness dimension extending perpendicular to said first surface and said second surface, wherein said first surface and said second surface of said blank plate have no recesses, wherein said blank plate is preferably formed by means of a technique selected from the group consisting of plate-pressing, tape casting, and extrusion of a mixture comprising said metallic particles and said polymer binder,
   and subsequent transformation of said blank plate into said green body plate by forming one or more recesses extending from said first surface into the thickness of the resulting green body plate, wherein said recesses are preferably formed by means of a technique selected from the group consisting of embossing said first surface of said blank plate and needling through the blank plate.

Embossing is especially preferred for forming recesses in the form of dimples, because forming dimples by means of embossing requires less material volume flow then forming grooves by means of embossing.

In a specific version of the above-defined second embodiment of the process for preparing a gas-permeable electronically conductive plate, a blank plate having a bilayer structure as defined above is formed, and subsequently said blank plate is transformed into a green body plate by forming one or more recesses in the form of dimples extending from said first surface into the thickness of the resulting green body plate by means of embossing in such manner that the depth of the dimple extends over 80 to 100%, preferably 90 to 100% of the thickness of the layer having the higher porosity and/or the higher average pore diameter which is configured to be in contact with the bipolar plate. In case the depth of said recesses extends over 100% of the thickness of the layer having the higher porosity and/or the higher average pore diameter which is configured to be in contact with the bipolar plate, the depth of said recesses may further extend over at most 50%, preferably at most 10% of the thickness of the adjacent layer having the lower porosity and/or the lower average pore diameter which is configured to be in contact with the catalyst layer. Thus, in case the depth of said dimples extends over 100% of the thickness of the first layer, the depth of said dimples may further extend from 0 to 50%, preferably from 0 to 10% of the thickness of said second layer. Limiting the depth of the dimples in such manner has the advantage of avoiding that embossing results in excessive densification of the porous structure near the second surface of the gas-permeable electronically conductive plate which is configured to be in contact with the catalyst layer, or even in a deformation of said second surface of the gas-permeable electronically conductive plate.

In step (ii), the green body plate prepared in step (i) is debinded to obtain a brown body plate without compromising its integrity and mechanical stability. Debinding means that at least a part of the binder is removed from the green body plate. In step (ii), any suitable technique for debinding may be used. For instance, step (ii) comprises one or more of thermal debinding, catalytical debinding and debinding by means of a solvent. Such debinding techniques are known in the art.

To remove at least a part of the binder by catalytical debinding, the green body plate is preferably exposed to an atmosphere comprising a gaseous acid. Appropriate processes are described, for example, in US 2009/0288739 and U.S. 5,145,900.

The debinding step (ii) is preferably carried out at temperatures below the melting temperature of the binder. In general, the debinding is carried out at a temperature in the range of from 20° C. to 150° C. and particularly preferably of from 100° C. to 140° C. Preferably, the debinding step is carried out for a period of from 0.1 hours to 24 hours, particularly preferably of from 0.5 hours to 12 hours. The time needed for debinding depends on the applied temperature, on the concentration of the acid in the treatment atmosphere and on the size of the green body plate.

Suitable acids for the debinding are, for example, inorganic acids which are either gaseous at room temperature or can be vaporized at or below the treatment temperature. Examples are hydrogen halides and nitric acid. Hydrogen halides are hydrogen fluoride, hydrogen chloride, hydrogen bromide and hydrogen iodide. Suitable organic acids are those, which have a boiling point at atmosphere pressure of less than 130° C., e.g. formic acid, acetic acid or trifluoroacetic acid and mixtures thereof. Acids with boiling points above 130° C., for example methanesulfonic acid, can be utilized in the debinding step in a mixture with a lower boiling acid and/or water. Preferred acids for process step (iii) are nitric acid, a 10% by weight solution of oxalic acid in water, and a mixture of 50% by volume of methanesulfonic acid in water. Furthermore, BF₃ and its adducts with inorganic ethers can be used as acids.

If a carrier gas is used, the carrier gas is generally passed through the acid and loaded with the acid before contacting with the green-body plate. The carrier gas loaded with the acid is then heated to the temperature at which the debinding is carried out. This temperature is advantageously higher than the loading temperature in order to avoid condensation of the acid. Preferably the temperature at which debinding is carried out is at least 1 K, particularly preferably at least 5 K and most preferably at least 10 K higher than the temperature at which the carrier gas is loaded with the acid.

Preference is given to mixing the acid into the carrier gas by means of a metering device and heating the gas mixture to such a temperature that the acid can no longer condense. Preferably, the temperature is at least 1 K, particularly preferably at least 5 K and most preferably at least 10 K higher than the sublimation and/or vaporization temperature of the acid and/or the carrier gas.

The carrier gas in general is any gas that is inert under the reaction conditions of the catalytic debinding step. A preferred carrier gas according to the present invention is nitrogen. The binder removal may also be carried out under reduced pressure.

In case of a green body plate containing the above-defined preferred binder, the catalytic debinding is preferably continued until the polyoxymethylene (POM) of the binder has been removed to an extent of at least 80% by weight, preferably at least 90% by weight, particularly preferably at least 95% by weight, based on the total weight of the POM. This may be checked by monitoring the weight decrease.

At the temperatures of the catalytic debinding step, the metal powder comprised in the green body plate may undergo chemical reactions and/or physical transitions. In particular, the particles of the metal powder may fuse together; undergo solid-state phase transitions and/or chemical reactions with the acidic atmosphere or carrier gas.

During the catalytic debinding step, the composition of the binder may change.

In step (iii) the brown body plate obtained in step (ii) is sintered under a non-oxidative atmosphere or vacuum to form a gas-permeable electronically conductive plate according to the first aspect as defined above. By means of sintering, the binder content is further decreased, and the metallic particles of the brown body plate are consolidated to form a contiguous body wherein the metallic particles are held together substantially without any binder.

In step (iii), during sintering the binder content is decreased to less than 5% by volume, preferably less than 2% by volume, particularly preferably less than 0.5% by volume and most preferably less than 0.01% by volume of the resulting gas permeable electronically conductive plate.

Preferably, in step (iii) sintering is carried out at a temperature in the range of from 700° C. to 1300° C.

The sintering step is preferably performed by using an atmosphere of argon, nitrogen, hydrogen, or a mixture of thereof at atmospheric pressures. The use of reduced pressures or vacuum, e.g. from about 10 kPa to about 80 kPa, preferably from about 20 kPa to about 50 kPa, is also possible.

During sintering the metallic particles in the brown body plate may undergo chemical reactions and/or physical transitions. Consequently, the composition, shape and size of the metallic particles comprised in the brown body plate obtained in step (ii) may differ from the gas permeable electronically conductive plate resulting after step (iii).

During sintering, the average pore diameter may increase.

A gas-permeable electronically conductive plate obtained by the process according to the above-defined fourth aspect has preferably one or more of the above-defined preferred features and/or is selected from the above-defined preferred embodiments disclosed in the context of the first aspect.

The following examples shall further illustrate the present invention without restricting the scope of this invention.

### EXAMPLES

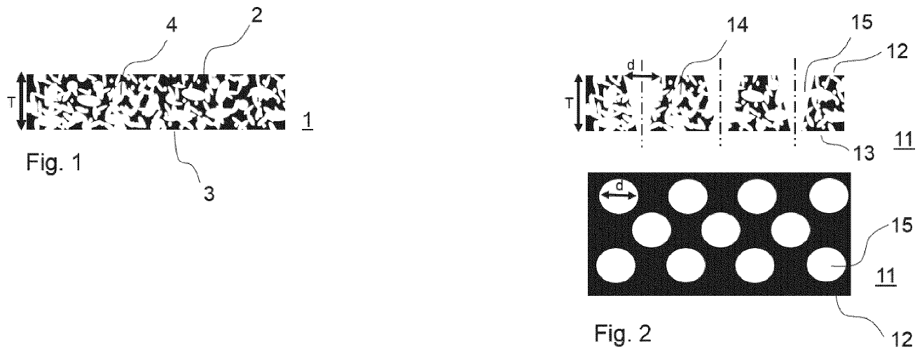

FIG. 1 shows a gas-permeable electronically conductive plate for use as porous transport layer for an electrolyzer.

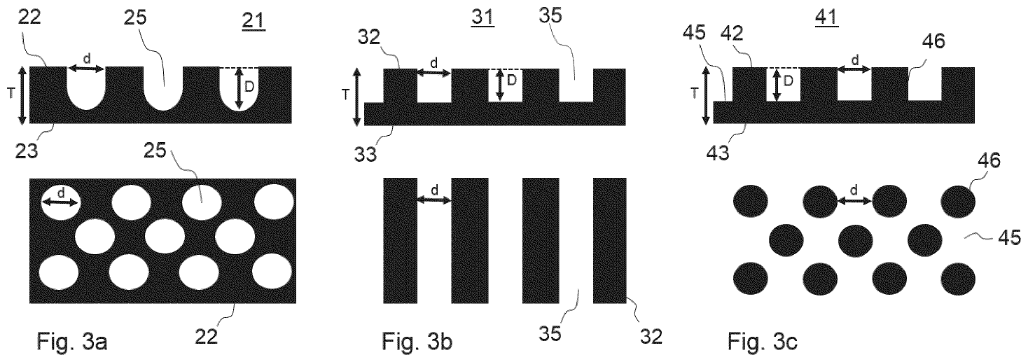

FIG. 2 shows a first preferred embodiment of a gas-permeable electronically conductive plate according to the invention.

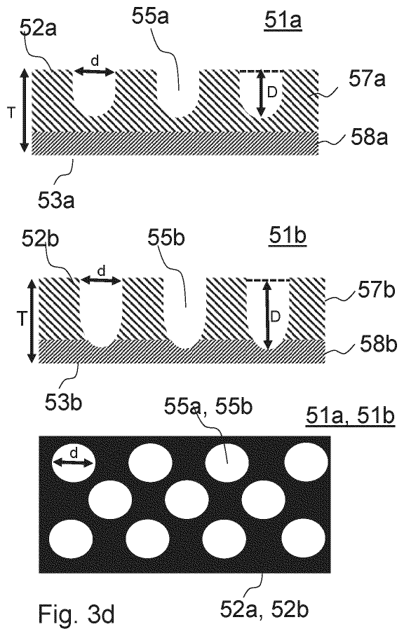

FIGS. 3a-c show examples of a second preferred embodiment of a gas-permeable electronically conductive plate according to the invention.

FIG. 3d shows another example of the second preferred embodiment of a gas-permeable electronically conductive plate according to the invention.

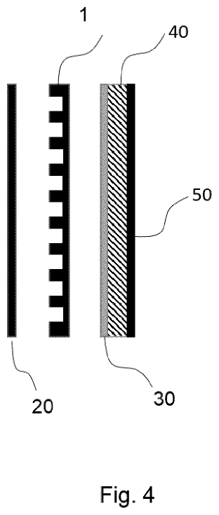

FIG. 4 shows a building unit for an electrolyzer.

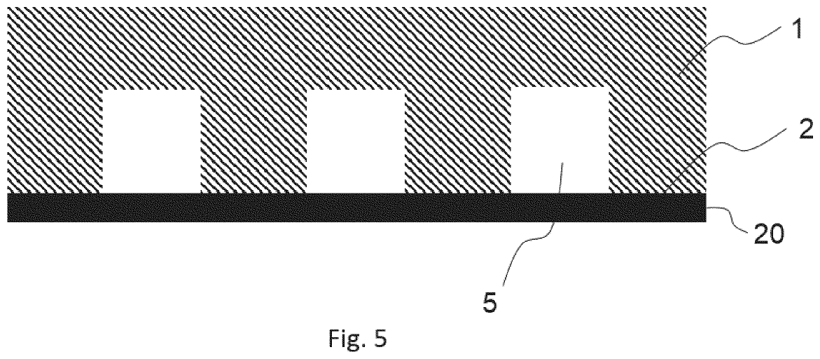

FIG. 5 shows a first preferred embodiment of a building unit for an electrolyzer.

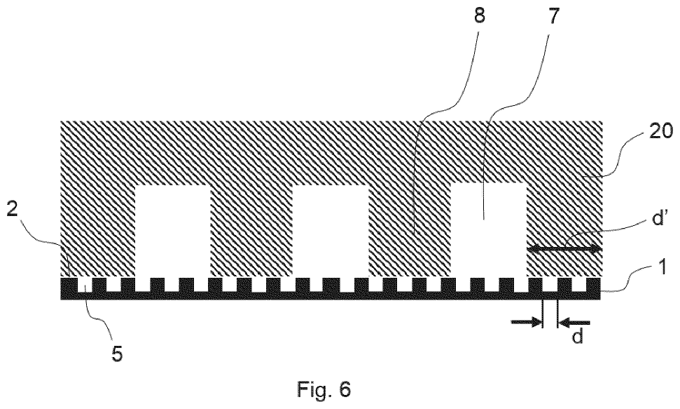

FIG. 6 shows a second preferred embodiment of a building unit for an electrolyzer.

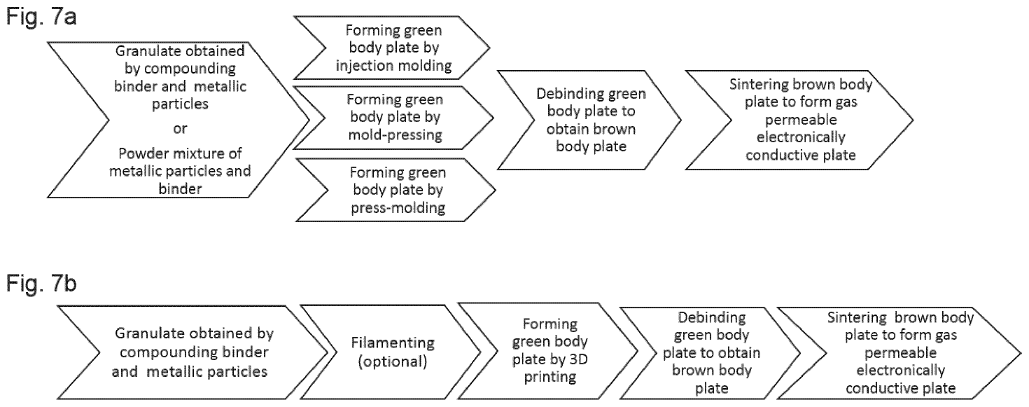

FIGS. 7a and 7b show flow diagrams of examples of a first embodiment of a process for preparing a gas-permeable electronically conductive plate.

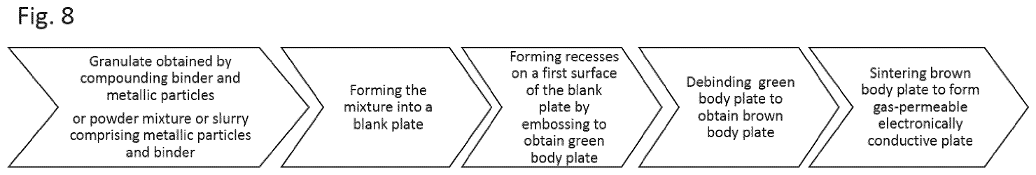

FIG. 8 shows a flow diagram of a second embodiment of a process for preparing a gas-permeable electronically conductive plate.

The figures are schematic and not drawn to scale.

FIG. 1 shows a cross section of a gas-permeable electronically conductive plate 1 for use as porous transport layer for an electrolyzer. Gas-permeable electronically conductive plate 1 comprises metallic particles of one or more selected from the group consisting of titanium, titanium alloys and stainless steel. The gas-permeable electronically conductive plate 1 has a plurality of pores 4 having an average pore diameter. The gas-permeable electronically conductive plate 1 has a first surface 2 and a second surface 3 opposite to each other, and a thickness dimension T extending perpendicular to first surface 2 and second surface 3. In a gas-permeable electronically conductive plate 1 according to the invention, the first surface 2 has one or more recesses (not shown in FIG. 1) extending from first surface 2 into the thickness T of the gas-permeable electronically conductive plate 1. Said recesses have a lateral dimension d at first surface 2 of the gas-permeable electronically conductive plate which is larger than the average pore diameter of the pores.

A first preferred embodiment of a gas-permeable electronically conductive plate according to the invention is shown in FIG. 2. The upper part of FIG. 2 is a cross section view of a gas-permeable electronically conductive plate 11 having a first surface 12 and a second surface 13. The lower part of FIG. 2 is a plane view of the first surface 12 of gas-permeable electronically conductive plate 11. The gas-permeable electronically conductive plate 11 has one or more recesses in the form of a through-hole 15 extending from the first surface 12 to the second surface 13 of gas-permeable electronically conductive plate 11. Said through-hole 15 has a central axis extending perpendicular from the first surface 12 to the second surface 13 of the gas-permeable electronically conductive plate 11. Through-hole 15 has a width at the level of first surface 12 of the gas-permeable electronically conductive plate 11. The width of trough-hole 15 at the level of the first surface 12 of the gas-permeable electronically conductive plate 11 is larger than the average pore diameter of the pores 14 of gas-permeable electronically conductive plate 11. Preferably, the width of trough-hole 15 at the level of the first surface 12 of the gas-permeable electronically conductive plate 11 is in the range of from 20 μm to 1000 μm, preferably 40 μm to 800 μm, more preferably 50 μm to 600 μm. Preferred are through-holes 15 having a width which is tapered in the direction from the first surface 12 to the second surface 13 of the of the gas permeable electronically conductive plate 11 (as shown in FIG. 2, upper part), so that the loss of contact interface with the catalyst layer at the second surface 13 of the of the gas permeable electronically conductive plate 11 is reduced

Through-hole 15 may have a circular contour (as shown in FIG. 2, lower part), or an oval, square, polygonal or any other suitable contour. Preferably, the diameter d of circular trough-hole 15 at the level of the first surface 12 of the gas-permeable electronically conductive plate 11 is in the range of from 20 μm to 1000 μm, preferably 40 μm to 800 μm, more preferably 50 μm to 600 μm. Preferred are through-holes 15 having a diameter d which is tapered in the direction from the first surface 12 to the second surface 13 of the of the gas permeable electronically conductive plate 11 (as shown in FIG. 2, upper part), so that the loss of contact interface with the catalyst layer at the second surface 13 of the of the gas permeable electronically conductive plate 11 is reduced.

In a second preferred embodiment, the gas-permeable electronically conductive plate has one or more recesses which have a depth which is lower than the thickness of the plate at a non-recessed position, and no recesses having a depth equal to the thickness of the gas-permeable electronically conductive plate are present. Examples of such embodiments are shown in FIGS. 3a-3c. For the sake of clarity, in these figures illustration of the porosity of gas-permeable electronically conductive plate 21, 31 and 41, resp., is omitted.

The upper part of FIG. 3a is a cross section view of a gas-permeable electronically conductive plate 21 having a first surface 22 and a second surface 23. The lower part of FIG. 3a is a plane view of first surface 22 of gas-permeable electronically conductive plate 21. In said plane view, non-recessed areas are shown in black, and recessed areas are shown in white. The gas-permeable electronically conductive plate 21 has one or more recesses in the form of a dimple 25 having a depth D extending from the first surface 22 into the thickness direction T of gas-permeable electronically conductive plate 21. The depth D of dimple 25 is lower than the thickness T of the gas permeable electronically conductive plate 21. The width of dimple 25 at the level of the first surface 22 of the gas-permeable electronically conductive plate 21 is larger than the average pore diameter of the pores (not shown in FIG. 3a) of gas-permeable electronically conductive plate 21. Preferably, the width of dimple 25 is in the range of from 10 μm to 5000 μm at the level of the first surface 22 of the gas permeable electronically conductive plate 21.

Dimple 25 may have a circular contour (as shown in FIG. 3a, lower part), or an oval, square, polygonal or any other suitable contour. Such dimple may have a U-shaped (as shown in FIG. 3a, upper part), V-shaped (triangular), square, semi-circle or any other suitable cross section. Preferably, the diameter d of circular dimple 25 is in the range of from 10 μm to 5000 μm at the level of the first surface 22 of the gas permeable electronically conductive plate 21. Dimple 25 may have a U-shaped (as shown in FIG. 3a, upper part), V-shaped (triangular), square, semi-circle or any other suitable cross section. The second surface 23 of gas-permeable electronically conductive plate 21 has no recesses.

The upper part of FIG. 3b is a cross section view of a gas-permeable electronically conductive plate 31 having a first surface 32 and a second surface 33. The lower part of FIG. 3b is a plane view of first surface 32 of gas-permeable electronically conductive plate 31. In said plane view, non-recessed areas are shown in black, and recessed areas are shown in white. The gas-permeable electronically conductive plate 31 has one or more recesses in the form of a groove 35 having a depth D extending from the first surface 32 into the thickness direction T of gas-permeable electronically conductive plate 31. The depth D of groove 35 is lower than the thickness T of the gas permeable electronically conductive plate 31. The width d of groove 35 at the level of the first surface 32 of gas-permeable electronically conductive plate 31 is larger than the average pore diameter of the pores (not shown in FIG. 3b) of gas-permeable electronically conductive plate 31. Preferably, groove 35 has a width d of from 10 μm to 5000 μm at the level of the first surface 32 of the gas permeable electronically conductive plate 31. Groove 35 may have a straight (as shown in the lower part of FIG. 3b), meander-like, zig-zag, serpentine, honey-comb or any other suitable course. Groove 35 may have a U-shaped, V-shaped (triangular), angular, square (as shown in the upper part of FIG. 3b), semi-circle or any other suitable cross section. Groove 35 may form a continuous channel extending from a fluid inlet to a fluid outlet. The second surface 33 of gas-permeable electronically conductive plate 31 has no recesses.

The upper part of FIG. 3c is a cross section view of a gas-permeable electronically conductive plate 41 having a first surface 42 and a second surface 43. The lower part of FIG. 3c is a plane view of first surface 42 of gas-permeable electronically conductive plate 41. In said plane view, non-recessed areas are shown in black, and recessed areas are shown in white. The gas-permeable electronically conductive plate 41 has a recessed area 45 extending around one or more island-like (insular) non-recessed sections 46 at the first surface 42 of gas-permeable electronically conductive plate 41. The depth D of recessed area 45 is lower than the thickness T of the gas permeable electronically conductive plate 41. Each non-recessed section 46 has a top surface at the level of the first surface 42 of the gas-permeable electronically conductive plate 41. The recessed area 45 surrounding the non-recessed sections 46 provides a passage for fluid flow around the non-recessed sections 46 which provide for electronic contact with the bipolar plate. The lateral distance d between the margins of neighboring non-recessed sections 46 at the level of the first surface 42 of gas-permeable electronically conductive plate 41 is larger than the average pore diameter of the pores (not shown in FIG. 3c) of gas-permeable electronically conductive plate 41. Preferably, the lateral distance between the margins of neighboring non-recessed sections 46 at first surface 42 is in the range of from 20 μm to 5000 μm as measured at the level of the first surface. The island-like (insular) non-recessed sections 46 may have a form of a ridge, a dam, a column (as shown in FIG. 3c), a pillar, a honeycomb, a truncated pyramid, a truncated conus, a step-like structure (i.e. a structure tapering towards the first surface of the gas-permeable electronically conductive plate 41), or any other suitable structure. Combinations of non-recessed sections 46 having different structures are possible. The second surface 43 of gas-permeable electronically conductive plate 41 has no recesses.

The upper part of FIG. 3d is a cross section view of a gas-permeable electronically conductive plate 51a having a first surface 52a and a second surface 53a. Gas-permeable electronically conductive plate 51a has a bilayer structure consisting of a first layer 57a and a second layer 58a, wherein the first layer 57a has a higher porosity and/or a higher average pore diameter than second layer 58a. The middle part of FIG. 3d is a cross section view of a gas-permeable electronically conductive plate 51b having a first surface 52b and a second surface 53b. Gas-permeable electronically conductive plate 51b has a bilayer structure consisting of a first layer 57b and a second layer 58b, wherein the first layer 57b has a higher porosity and/or a higher average pore diameter than second layer 58b. Layer 57a resp. 57b is configured to be in contact with a bipolar plate, and layer 58a resp. 58b is configured to be in contact with a catalyst layer.

The lower part of FIG. 3d is a plane view of first surface 52a of gas-permeable electronically conductive plate 51a resp. first surface 52b of gas-permeable electronically conductive plate 51b. In said plane view, non-recessed areas are shown in black, and recessed areas are shown in white.

The gas-permeable electronically conductive plate 51a has a plurality of recesses in the form of a dimple 55a having a depth D extending from the first surface 52a into the thickness direction T of gas-permeable electronically conductive plate 51a. The depth D of dimple 55a is lower than the thickness T of the gas permeable electronically conductive plate 51a and extends over 80 to 100% of the thickness of layer 57a of gas-permeable electronically conductive plate 51a, and not into the thickness of layer 58a of gas-permeable electronically conductive plate 51a (upper part of FIG. 3d). Dimples 55a are evenly distributed over the first surface 52a of gas-permeable electronically conductive plate 51a.

The gas-permeable electronically conductive plate 51b has a plurality of recesses in the form of a dimple 55b having a depth D extending from the first surface 52b into the thickness direction T of gas-permeable electronically conductive plate 51b. The depth D of dimple 55b is lower than the thickness T of the gas permeable electronically conductive plate 51b and extends over 100% of the thickness of layer 57b and over at most 50%, preferably at most 10% of the thickness of layer 58b of gas-permeable electronically conductive plate 51b (middle part of FIG. 3d). Dimples 55b are evenly distributed over the first surface 52b of gas-permeable electronically conductive plate 51b.

The width of dimples 55a at the level of the first surface 52a of the gas-permeable electronically conductive plate 51a is larger than the average pore diameter of the pores of layer 57a of said gas-permeable electronically conductive plate 51a. The width of dimples 55b at the level of the first surface 52b of the gas-permeable electronically conductive plate 51b is larger than the average pore diameter of the pores of layer 57b of said gas-permeable electronically conductive plate 51b.

Preferably, the width of dimples 55a resp. 55b is in the range of from 10 μm to 5000 μm at the level of the first surface 52a resp. 52b of the gas permeable electronically conductive plate 51a resp. 51b. Dimples 55a resp. 55b may have a circular contour (as shown in FIG. 3d, lower part), or an oval, square, polygonal or any other suitable contour. Dimples 55a, 55b may have a U-shaped (as shown in FIG. 3d, upper part and middle part), V-shaped (triangular), square, semi-circle or any other suitable cross section. Preferably, the diameter d of circular dimples 55a resp. 55b is in the range of from 10 μm to 5000 μm at the level of the first surface 52a, resp. 52b of the gas permeable electronically conductive plate 51a resp. 51b. The second surface 53a of gas-permeable electronically conductive plate 51a resp. the second surface 53b of gas-permeable electronically conductive plate 51b has no recesses.

FIG. 4 shows a cross section view of a building unit for an electrolyzer. Said building unit comprises or consists of
a gas-permeable electronically conductive plate 1 according to the above-defined first aspect
a gas-impermeable electronically conductive bipolar plate 20 in contact with first surface 2 of gas-permeable electronically conductive plate 1,
a catalyst layer 30 in contact with second surface 3 of gas-permeable electronically conductive plate 1.

As explained above, in said building unit at least one of
a gas-impermeable electronically conductive bipolar plate 20 in contact with first surface 2 of gas-permeable electronically conductive plate 1
   and
a catalyst layer 30 in contact with second surface 3 of gas-permeable electronically conductive plate 1
   must be present beside the gas-permeable electronically conductive plate 1.

In FIG. 4, gas-permeable electronically conductive plate 1 is preferably one according to any of the preferred embodiments illustrated in FIGS. 2, and 3a-c.

In FIG. 4, catalyst layer 30 is an anode catalyst layer and comprises a catalyst capable of catalyzing the electrochemical oxygen evolution. Said catalyst is preferably selected from the group consisting of iridium, iridium oxide, platinum, platinum oxide, palladium, palladium oxide, ruthenium, ruthenium oxide and mixtures of the oxides listed herein. The catalyst is unsupported or is supported on a suitable catalyst carrier, for instance on a catalyst carrier selected from the group consisting of SnO₂, TiO₂, and carbon black.

Merely for illustrative purposes, FIG. 4 also shows proton exchange membrane 40 in contact with anode catalyst layer 30, and cathode catalyst layer 50 in contact with proton exchange membrane 40. However, proton exchange membrane 40 and cathode catalyst layer 50 are not mandatory parts of a building unit according to the above-defined second aspect.

FIG. 5 shows a cross section view of a first preferred embodiment of a building unit for an electrolyzer. Said building unit comprises or consists of
a gas-permeable electronically conductive plate 1, wherein the recesses 5 at the first surface 2 of gas-permeable electronically conductive plate 1 preferably have a lateral dimension in the range of from 100 μm to 5000 μm,
and a gas-impermeable electronically conductive bipolar plate 20 having a surface in contact with first surface 2 of gas-permeable electronically conductive plate 1, wherein said surface of bipolar plate 20 which is in contact with first surface 2 of gas-permeable electronically conductive plate 1 has no recesses.

In the embodiment shown in FIG. 5, the bipolar plate 20 merely provides electronic contact between neighboring cells of the electrolyzer and does not provide any fluid flow structure. Any reactant transport occurs within the gas-permeable electronically conductive plate 1. In order to facilitate lateral reactant transport, it is preferred that the gas-permeable electronically conductive plate 1 has at least one recess 5 in the form or continuous channel or in the form of a continuous recessed area extending around a plurality of island-like (insular) non-recessed sections. Continuous means that the recess 5 extends from a fluid inlet connected to the fluid supply manifold of the electrolyzer to a fluid outlet connected to a fluid removal manifold of the electrolyzer. The one or more recesses 5 at first surface 2 of gas-permeable electronically conductive plate 1 preferably have a lateral dimension (e.g. a channel width d) in the range of from 100 μm to 5000 μm. This dimension is in the same range as the lateral dimension (e.g. channel width) of commonly used flow field structures for state of the art bipolar plates.

FIG. 6 shows a cross section view of a second preferred embodiment of a building unit for an electrolyzer. Said building unit comprises or consists of
a gas-permeable electronically conductive plate 1,
and a gas-impermeable electronically conductive bipolar plate 20 having a flow field surface in contact with first surface 2 of gas-permeable electronically conductive plate 1,
wherein the flow field surface of bipolar plate 20 has a fluid flow structure comprising recesses 7 extending between protruding areas 8, wherein one or more of protruding areas 8 extend over one or more of the recesses 5 at the first surface 2 of gas-permeable electronically conductive plate 1,
wherein preferably the protruding areas 8 at the flow field surface of the bipolar plate 20 have a lateral dimension d′, which is larger than the lateral dimension d of recesses 5 at said first surface 2 of gas-permeable electronically conductive plate 1.

In the embodiment shown in FIG. 6, the bipolar plate 20 and the adjacent first surface 2 of the gas-permeable electronically conductive plate 1 cooperate in providing a fluid flow structure for the reactant transport.

The bipolar plate 20 has a flow field surface in contact with the first surface 2 of gas-permeable electronically conductive plate 1. The first surface 2 of gas-permeable electronically conductive plate 1 has one or more recesses 5 extending from first surface 2 into the thickness T of the gas-permeable electronically conductive plate 1. The flow field surface of bipolar plate 20 has a fluid flow structure comprising recesses 7 extending between protruding areas 8. Such fluid flow structure is also referred to as a flow-field. Suitable flow-field designs are known in the art. Typically, a flow field comprises at least one recess 7 which forms a continuous channel extending between two protruding areas 8 which provide the walls of the channel. Continuous means that recess 7 extends from a fluid inlet connected to the fluid supply manifold of the electrolyzer to a fluid outlet connected to a fluid removal manifold of the electrolyzer.

In the building unit according to FIG. 6, one or more of said protruding areas 8 of the flow field surface of the bipolar plate 20 extend over one or more of the recesses 5 at the first surface 2 of the gas-permeable electronically conductive plate 1 adjacent to the flow field surface of the bipolar plate 20.

Preferably, as shown on FIG. 6, the protruding areas 8 at the flow field surface of the bipolar plate 20 have a lateral dimension d′ which is larger than the lateral dimension d of recesses 5 at the first surface 2 of gas-permeable electronically conductive plate 1 adjacent to the flow-field surface of the bipolar plate 20. The lateral dimension d′ of the protruding areas 8 at the flow field surface of the bipolar plate 20 is preferably in the range of from 100 μm to 5000 μm, and the lateral dimension d of recesses 5 at the first surface 2 of gas-permeable electronically conductive plate 1 is preferably in the range of from 10 μm to 1000 μm.

FIG. 7a shows an example a first embodiment of a process for preparing a gas-permeable electronically conductive plate starting from a powder mixture comprising metallic particles and binder, or from a granulate obtained by compounding a binder and metallic particles. In step (i), said powder mixture resp. said granulate is formed into a green body plate by e.g. any of injection molding, press-molding and mold-pressing. In step (ii), said green body plate is debinded to obtain a brown body plate. In step (iii), said brown body plate is sintered to form gas permeable electronically conductive plate.

FIG. 7b shows another example of the first embodiment of a process for preparing a gas-permeable electronically conductive plate starting from a granulate obtained by compounding a binder and metallic particles. The granulate obtained by compounding the metallic particles with a liquid binder or a liquefied binder or a solid binder may be transferred into a 3D printing filament by means of fused filament fabrication. Such techniques are known in the art. In step (i), said granulate or said filament is formed into a green body plate by 3D-printing. In step (ii), said green body plate is debinded to obtain brown body plate. In step (iii), said brown body plate is sintered to form gas permeable electronically conductive plate.

FIG. 8 shows an example of a second embodiment of a process for preparing a gas-permeable electronically conductive plate starting from a powder mixture or a slurry comprising metallic particles and a binder, or from a granulate obtained by compounding binder and metallic particles. In step (i), said mixture is formed into a blank plate by e.g. any of plate pressing of said powder mixture, tape casting of said slurry, and extrusion of said granulate.

Said blank plate has a first surface and a second surface opposite to each other, and a thickness dimension extending perpendicular to said first surface and said second surface, wherein said first surface and said second surface of said blank plate have no recesses. Step (i) also comprises subsequent transformation of said blank plate into a green body plate by forming one or more recesses extending from said first surface into the thickness of the resulting green body plate. Said recesses are preferably formed by means of a technique selected from the group consisting of embossing said first surface of said blank plate and needling through the blank plate. In step (ii), said green body plate is debinded to obtain brown body plate. In step (iii), said brown body plate is sintered to form gas permeable electronically conductive plate.

Preparation of green body plates (step (i)) having different types of recesses on the first surface was carried out as follows:

### Example 1: Green Body Plate Having a Honeycomb Pattern on the First Surface

A granulate obtained by compounding titanium powder and a binder according to not pre-published PCT-application WO 2023/061869 (titanium content in the range of from 50 to 65 vol %.) was formed into a blank plate having a thickness of 640 μm and lateral dimensions of about 10 cm×10 cm by hot-pressing between two plates heated to a temperature of 165° C. The thickness of the blank plate was controlled by means of spacers arranged between the two heated plates. Said blank plate has a first surface and a second surface without recesses.

The blank plate was transferred into a green body plate by creating a honeycomb-structure on the first surface of the plate by means of embossing with a stainless steel plate carrying a laser-generated pattern which forms a negative of the pattern to be formed on the first surface of the green body plate. Embossing was carried out by means of a calender (Saueressig GKL 300L) applying a roll temperature of 150° C. and a pressure of 0.4 MPa at 500 μm fixed gap.

The first surface of the obtained green body plate has a honeycomb pattern comprising island-like (insular) six-angular non-recessed sections having a width of 4500 μm sur-rounded by a recessed area having a width of 600 μm (distance between the margins of neighboring honeycombs) and a depth of about 140 μm.

### Example 2: Green Body Plate Having a Pillar Array on the First Surface

A granulate obtained by compounding titanium powder and a binder according to not pre-published PCT-application WO 2023/061869 (titanium content in the range of from 50 to 65 vol %.) was formed into a blank plate having a thickness of 640 μm and lateral dimensions of about 10 cm×10 cm by hot-pressing between two plates heated to a temperature of 165° C. The thickness of the blank plate was controlled by means of spacers arranged between the two heated plates. Said blank plate has a first surface and a second surface without recesses.

The blank plate was transferred into a green body plate by creating a pillar array on the first surface of the plate by means of embossing with a stainless steel plate carrying a laser-generated pattern which forms a negative of the pattern to be formed on the first surface of the green body plate. Embossing was carried out by means of a calender (Saueressig GKL 300L) applying a roll temperature of 150° C. and a pressure of 4 MPa at 500 μm fixed gap.

The first surface of the obtained green body plate has a pillar array comprising island-like (insular) pillar-shaped non-recesses sections having a diameter of around 600 μm sur-rounded by a recessed area having a width (distance between the margins of neighboring pillars) of about 400 μm and a depth of about 180 μm.

### Example 3: Green Body Plate Having a Pillar Array on the First Surface

A granulate obtained by compounding titanium powder and a binder according to not pre-published PCT-application WO 2023/061869 (titanium content in the range of from 50 to 65 vol %.) was formed into a blank plate having a thickness of 640 μm and lateral dimensions of about 10 cm×10 cm by hot-pressing between two plates heated to a temperature of 165° C. The thickness of the blank plate was controlled by means of spacers arranged between the two heated plates. Said blank plate has a first surface and a second surface without recesses.

The blank plate was transferred into a green body plate by creating a pillar array on the first surface of the plate by means of embossing with a 200 μm thick laser patterned stainless steel plate (carrying a pattern which forms a negative of the pattern to be formed on the first surface of the green body plate) in a calender (Saueressig GKL 300L) applying a roll temperature of 150° C. and a pressure of 4 MPa at 500 μm fixed gap.

The first surface of the obtained green body plate has a pillar array comprising island-like (insular) pillar-shaped non-recesses sections having a diameter of around 200 μm sur-rounded by a recessed area having a width (distance between the margins of neighboring pillars) of about 200 μm and a depth of about 80 μm.

### Example 4: Green Body Plate Having Parallel Channels on the First Surface

A granulate obtained by compounding titanium powder and a binder according to not pre-published PCT-application WO 2023/061869 (titanium content in the range of from 50 to 65 vol %.) was formed into a blank plate having a thickness of 640 μm and lateral dimensions of about 10 cm×10 cm by hot-pressing between two plates heated to a temperature of 165° C. The thickness of the blank plate was controlled by means of spacers arranged between the two heated plates. Said blank plate has a first surface and a second surface without recesses.

The blank plate was transferred into a green body plate by creating parallel channels on the first surface of the plate by means of embossing with a stainless steel plate carrying a laser-generated pattern which forms a negative of the pattern to be formed on the first surface of the green body plate. Embossing was carried out by means of a calender (Saueressig GKL 300L) applying a roll temperature of 150° C. and a pressure of 4 MPa at 500 μm fixed gap.

The first surface of the obtained green body plate has recesses in the form of parallel channels having a V-shaped cross-section, a width of 0.1 mm measured at the level of the first surface and a depth of about 80 μm. The thickness of the walls between the channels measured at the level of the deepest point of the channels is about 200 μm.

### Example 5: Green Body Plate Having Parallel Channels on the First Surface

A granulate obtained by compounding titanium powder and a binder according to not pre-published PCT-application WO 2023/061869 (titanium content in the range of from 50 to 65 vol %.) was formed into a blank plate having a thickness of 640 μm and lateral dimensions of about 10 cm×10 cm by hot-pressing between two plates heated to a temperature of 165° C. The thickness of the blank plate was controlled by means of spacers arranged between the two heated plates. Said blank plate has a first surface and a second surface without recesses.

The blank plate was transferred into a green body plate by creating parallel channels on the first surface of the plate by means of embossing with a stainless steel plate carrying a laser-generated pattern which forms a negative of the pattern to be formed on the first surface of the green body plate. Embossing was carried out by means of a calender (Saueressig GKL 300L) applying a roll temperature of 150° C. and a pressure of 4 MPa at 500 μm fixed gap.

The first surface of the obtained green body plate has recesses in the form of parallel channels having a U-shaped cross-section, a width of 100 μm measured at the level of the first surface and a depth of about 180 μm. The thickness of the walls between the channels measured at the level of the deepest point of the channels is about 300 μm.

A green body plate obtained according to any of examples 1 to 7 is debinded (step (ii)) to obtain a brown body plate and the obtained brown body plate is sintered (step (iii) under a non-oxidative atmosphere or vacuum to form the gas-permeable electronically conductive plate for use as porous transport layer for an electrolyzer.

### Example 6: Green Body Plate Having a Dimple Array on the First Surface and a Bilayer Structure

A blank plate having a total thickness of 420 μm and lateral dimensions of about 10 cm×10 cm was obtained by co-extruding equal masses of a first and a second granulate obtained by compounding titanium powder and a binder according to not prepublished PCT-application WO 2023/061869. The titanium content of the first granulate is in the range of from 50 to 65 vol %, and the titanium content of the second granulate is in the range of from 65 to 85 vol %, wherein the titanium content of the second granulate is selected to be higher than in the first granulate. The obtained blank plate has a first surface and a second surface without recesses and comprises 2 layers of equal thickness (210 μm in each case) which differ in titanium/binder ratio.

The blank plate was transferred into a green body plate by creating a dimple array on the first surface of the plate by means of embossing with a 500 μm thick etched stainless steel plate (carrying a pattern which forms a negative of the pattern to be formed on the first surface of the green body plate) in a calender (Saueressig GKL 300L) applying a roll temperature of 150° C. and a pressure of 4 MPa at 500 μm fixed gap.

The first surface of the obtained green body plate has an array comprising dimple-shaped recesses sections having a diameter of around 300 μm having a depth of around 300 μm and distance between the margins of neighboring dimples of about 300 μm.

### Example 7: Green Body Plate Having a Dimple Array on the First Surface and a Bilayer Structure

A blank plate having a total thickness of 420 μm and lateral dimensions of about 10 cm×10 cm was obtained by co-extruding different amounts of a first and a second granulate obtained by compounding titanium powder and a binder according to not prepublished PCT-application WO 2023/061869. The titanium content of the first granulate is in the range of from 50 to 65 vol %, and the titanium content of the second granulate is in the range of from 65 to 85 vol %, wherein the titanium content of the second granulate is selected to be higher than in the first granulate. The obtained blank plate has a first surface and a second surface without recesses and comprises 2 layers of different thickness (first layer obtained from the first granulate: 260 μm, second layer obtained from the second granulate 160 μm) which differ in titanium/binder ratio.

The blank plate was transferred into a green body plate by creating a dimple array on the first surface of the plate by means of embossing with a 500 μm thick etched stainless steel plate (carrying a pattern which forms a negative of the pattern to be formed on the first surface of the green body plate) in a calender (Saueressig GKL 300L) applying a roll temperature of 150° C. and a pressure of 4 MPa at 500 μm fixed gap.

The first surface of the obtained green body plate has an array comprising dimple-shaped recesses sections having a diameter of around 300 μm having a depth of around 300 μm and distance between the margins of neighboring dimples of about 300 μm.

### Example 8: Green Body Plate Having a Dimple Array on the First Surface

A granulate obtained by compounding titanium powder and a binder according to not pre-published PCT-application WO 2023/06186 (titanium content in the range of from 50 to 85 vol %.) was formed into a blank plate having a thickness of 420 μm and lateral dimensions of about 10 cm×10 cm by hot-pressing between two plates heated to a temperature of 165° C. The thickness of the blank plate was controlled by means of spacers arranged between the two heated plates. Said blank plate has a first surface and a second surface without recesses.

The blank plate was transferred into a green body plate by creating a dimple array on the first surface of the plate by means of embossing with a 500 μm thick etched stainless steel plate (carrying a pattern which forms a negative of the pattern to be formed on the first surface of the green body plate) in a calender (Saueressig GKL 300L) applying a roll temperature of 150° C. and a pressure of 4 MPa at 500 μm fixed gap.

The first surface of the obtained green body plate has a dimple array comprising dimple-shaped recesses sections having a diameter of around 300 μm having a depth of around 300μm and distance between the margins of neighboring dimples of about 300 μm.

1.-14. (canceled)

15. A gas-permeable electronically conductive plate for use as porous transport layer for an electrolyzer, the gas-permeable electronically conductive plate comprising:
comprising metallic particles of one or more selected from the group consisting of titanium, titanium alloys and stainless steel;
a plurality of pores having an average pore diameter;
a first surface and a second surface opposite to each other, and a thickness dimension extending perpendicular to the first surface and the second surface;
wherein the first surface of the gas-permeable electronically conductive plate has one or more recesses extending from the first surface into the thickness of the gas-permeable electronically conductive plate;
wherein the recesses comprise a lateral dimension at the first surface of the gas-permeable electronically conductive plate which is larger than the average pore diameter of the pores;
wherein at least one of the one or more recesses has a depth which is lower than the thickness of the gas-permeable electronically conductive plate at a non-recessed position;
wherein at least one of the one or more recesses is in a form of a dimple; and
a first layer; and
a second layer;
wherein the first layer has a higher porosity and/or a higher average pore diameter than the second layer; and
wherein the depth of the dimple extends over 80 to 100% of the thickness of the first layer, and in case the depth of the dimple extends over 100% of the thickness of the first layer, the depth of the dimple may further extend from 0 to 50% of the thickness of the second layer.

16. A gas-permeable electronically conductive plate according to claim 15, wherein the one or more recesses are a through-hole extending from the first surface to the second surface of the gas-permeable electronically conductive plate, the through-hole having:
a central axis extending perpendicular from the first surface to the second surface; and
a diameter at the first surface which is in the range of from 20 μm to 1000 μm.

17. The gas-permeable electronically conductive plate according to claim 15, wherein none of the one or more recesses have a depth equal to the thickness of the gas-permeable electronically conductive plate.

18. The gas-permeable electronically conductive plate according to claim 15, wherein the width of the dimple at the first surface is in the range of from 10 μm to 5000 μm.

19. The gas-permeable electronically conductive plate according to claim 15, wherein the gas-permeable plate has at least one of the following:
a thickness in the range of from 20 μm to 2000 μm as measured at a position where there is no recess;
a porosity in the range of from 10 vol % to 80 vol %, as measured by volume intrusion mercury porosimetry in accordance with DIN 66133; and
an average pore diameter in the range of from 5 μm to 40 μm as measured by volume intrusion mercury porosimetry in accordance with DIN 66133.

20. A building unit for an electrolyzer, the building unit comprising:
a gas-permeable electronically conductive plate as defined in claim 15; and
at least one of:
a gas-impermeable electronically conductive bipolar plate in contact with the first surface of the gas-permeable electronically conductive plate; and
a catalyst layer in contact with the second surface of the gas-permeable electronically conductive plate, wherein the catalyst layer comprises a catalyst capable of catalyzing the electrochemical oxygen evolution reaction.

21. The building unit according to claim 20, wherein:
the one or more recesses at the first surface of the gas-permeable electronically conductive plate has a lateral dimension (d) in the range of from 100 μm to 5000 μm; and
the gas-impermeable electronically conductive bipolar plate has a bipolar plate surface in contact with the first surface of the gas-permeable electronically conductive plate, the bipolar plate surface of the gas-impermeable electronically conductive bipolar plate has no recesses.

22. The building unit according to claim 20, wherein:
the gas-impermeable electronically conductive bipolar plate comprises a flow field surface in contact with the first surface of the gas-permeable electronically conductive plate;
the flow field surface of the gas-impermeable electronically conductive bipolar plate has a fluid flow structure comprising a fluid flow recesses extending between a plurality of protruding areas;
one or more of the plurality of protruding areas extends over the one or more recesses at the first surface of the gas-permeable electronically conductive plate; and
the plurality of protruding areas at the flow field surface of the gas-impermeable electronically conductive bipolar plate have a lateral dimension which is larger than the lateral dimension of the one or more recesses at the first surface of the gas-permeable electronically conductive plate.

23. An electrolyzer comprising one of:
the gas-permeable electronically conductive plate as defined in claim 15; or
a building unit comprising:
the gas-permeable electronically conductive plate as defined in claim 15; and
at least one of:
a gas-impermeable electronically conductive bipolar plate in contact with the first surface of the gas-permeable electronically conductive plate; and
a catalyst layer in contact with the second surface of the gas-permeable electronically conductive plate, wherein the catalyst layer comprises a catalyst capable of catalyzing the electrochemical oxygen evolution reaction;
wherein the electrolyzer is an electrolyzer for electrolysis of water comprising an electrolyte in the form of a proton exchange membrane.

24. A process for preparing the gas-permeable electronically conductive plate of claim 15, the process comprising the steps of:
(i) forming a mixture comprising metallic particles of one or more selected from the group consisting of titanium, titanium alloys and stainless steel, and a polymer binder into a green body plate,
wherein the green body plate comprises a first green body plate surface and a second green body plate surface opposite to each other, and a thickness dimension extending perpendicular to the first green body plate surface and the second green body plate surface,
wherein the average particle size of the metallic particles varies stepwise along the thickness dimension of the green body plate resulting in a bilayer structure wherein the average particle size of the metallic particles decreases along the thickness in the direction from the first green body plate surface towards the second green body plate surface;
wherein the volume ratio between the metallic particles and the binder varies stepwise along the thickness dimension of the green body plate resulting in a bilayer structure wherein the volume ratio between the metallic particles and the binder increases along the thickness in the direction from the first green body plate surface towards the second green body plate surface;
wherein the first green body plate surface has one or more green body plate recesses extending from the first green body plate surface into the thickness of the green body plate,
wherein at least one of the one or more green body plate recesses has a depth which is lower than the thickness of the green body plate at a non-recessed position, wherein at least one of the one or more green body plate recesses are in a form of a dimple; and/or
wherein the one or more green body plate recesses comprise a lateral dimension at the first green body plate surface in the range from 11 μm to 5500 μm;
(ii) debinding the green body plate prepared in step (i) to obtain a brown body plate; and
(iii) sintering the brown body plate obtained in step (ii) under a non-oxidative atmosphere or vacuum to form the gas-permeable electronically conductive plate.

25. The process according to claim 24, wherein the metallic particles have an average particle size of from 15 μm to 106 μm as measured by laser diffraction.

26. The process according to claim 24, wherein step (i) further comprises at least one of:
(a) forming a mixture comprising the metallic particles and the polymer binder into the green body plate wherein the green body plate is formed by means of a technique selected from the group consisting of injection molding, press-molding, mold-pressing and 3D-printing a mixture comprising the metallic particles and the polymer binder; and
(b) forming a mixture comprising the metallic particles and the polymer binder into a blank plate having a first blank plate surface and a second blank plate surface opposite to each other, and a thickness dimension extending perpendicular to the first blank plate surface and the second blank plate surface, wherein the first blank plate surface and the second blank plate surface have no recesses, wherein the blank plate is formed by means of a technique selected from the group consisting of plate pressing, tape casting, and extrusion of a mixture comprising the metallic particles and the polymer binder;
wherein subsequent transformation of the blank plate into the green body plate by forming the one or more green body plate recesses extending from the first green body plate surface into the thickness of the resulting green body plate, wherein the one or more green body plate recesses are formed by means of a technique selected from the group consisting of embossing the first blank plate surface.

27. The process according to claim 24, wherein:
step (ii) comprises one or more of thermal debinding, catalytical debinding and debinding by means of a solvent; and/or
in step (iii) sintering is carried out at a temperature in the range of from 700° C. to 1300° C.
